(19) United States
(12) Patent Application Publication
(10) Pub. No.: US 2016/0142510 A1
(43) Pub. Date: May 19, 2016

(54) CACHE-AWARE CONTENT-BASED RATE ADAPTATION MECHANISM FOR ADAPTIVE VIDEO STREAMING

(71) Applicant: Futurewei Technologies, Inc., Plano, TX (US)

(72) Inventors: Cedric Westphal, San Francisco, CA (US); Francesco Bronzino, North Brunswick, NJ (US)

(21) Appl. No.: 14/940,656

(22) Filed: Nov. 13, 2015

Related U.S. Application Data
(60) Provisional application No. 62/079,956, filed on Nov. 14, 2014.

(51) Int. Cl. H04L 29/08; H04L 29/06

(52) U.S. Cl. CPC H04L 67/322; H04L 65/80; H04L 65/60

(57) ABSTRACT

An apparatus is configured to perform a method for adaptive video streaming. The method includes determining a link quality or throughput in at least one of: a first link from a server to an intermediate node or a second link from the intermediate node to a client device. The method also includes, based on the determined link quality or throughput, estimating a link quality in a future time period for at least one of: the first link or the second link. The method further includes determining a schedule for downloading video segments from the server to a cache associated with the intermediate node, the schedule determined based on the estimated link quality in the future time period. In addition, the method includes downloading video segments according to the schedule from the server to the cache during the future time period.

### CROSS-REFERENCE TO RELATED APPLICATION(S) AND CLAIM OF PRIORITY

This application claims priority under 35 U.S.C. §119(e) to U.S. Provisional Patent Application No. 62/079,956, filed Nov. 14, 2014, entitled “CACHE-AWARE CONTENT-BASED RATE ADAPTATION MECHANISM FOR ADAPTIVE VIDEO STREAMING”, which is hereby incorporated by reference into this application as if fully set forth herein.

### TECHNICAL FIELD

The present disclosure relates generally to adaptive video streaming, and more particularly, to a cache-aware content-based rate adaptation mechanism for adaptive video streaming.

### BACKGROUND

Video consumption over the Internet has experienced a continuous growth in the last few years and while it now accounts for about two thirds of the total amount of global Internet traffic, its share is expected to increase to up to 79% by 2018. While video streaming services continue to rise in popularity thanks to a large availability of content and reduced costs, Internet service providers are struggling to provide high quality services to their costumers due to their inability to allocate enough capacity to meet such demand, especially at peak hours.

Moreover, the ongoing surge of video consumption from mobile devices introduces additional challenges due to the high levels of variability generated by the characteristics of wireless networks. Meeting the required levels of service under such variability it is indeed very difficult. While there have been efforts to improve the quality of service by employing either new technologies, such as 4G broadband, or performance enhancement techniques, such as a combination of multiple interfaces, these solutions can result in additional problems for service providers as they introduce even higher levels of variability into the network.

### SUMMARY

According to one embodiment, a method for adaptive video streaming is provided. The method includes determining a link quality or throughput in at least one of: a first link from a server to an intermediate node or a second link from the intermediate node to a client device. The method also includes, based on the determined link quality or throughput, estimating a link quality in a future time period for at least one of: the first link or the second link. The method further includes determining a schedule for downloading video segments from the server to a cache associated with the intermediate node, the schedule determined based on the estimated link quality in the future time period. In addition, the method includes downloading video segments according to the schedule from the server to the cache during the future time period, in order to make the video segments available in the cache for transmission to the client device.

According to another embodiment, an apparatus for adaptive video streaming is provided. The apparatus includes at least one memory and at least one processor coupled to the at least one memory. The at least one processor is configured to determine a link quality or throughput in at least one of: a first link from a server to an intermediate node or a second link from the intermediate node to a client device; based on the determined link quality or throughput, estimate a link quality in a future time period for at least one of: the first link or the second link; determine a schedule for downloading video segments from the server to a cache associated with the intermediate node, the schedule determined based on the estimated link quality in the future time period; and download video segments according to the schedule from the server to the cache during the future time period, in order to make the video segments available in the cache for transmission to the client device.

According to a further embodiment, a non-transitory computer readable medium embodying a computer program is provided. The computer program includes computer readable program code for determining a link quality or throughput in at least one of: a first link from a server to an intermediate node or a second link from the intermediate node to a client device; based on the determined link quality or throughput, estimating a link quality in a future time period for at least one of: the first link or the second link; determining a schedule for downloading video segments from the server to a cache associated with the intermediate node, the schedule determined based on the estimated link quality in the future time period; and downloading video segments according to the schedule from the server to the cache during the future time period, in order to make the video segments available in the cache for transmission to the client device.

Other technical features may be readily apparent to one skilled in the art from the following figures, descriptions, and claims.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an example of an information centric network according to this disclosure;

FIG. 2 illustrates an example of an information centric network for use with the rate and streaming algorithms according to this disclosure;

FIGS. 3A and 3B illustrate examples of video bandwidth and download capacity in an information centric network according to this disclosure;

FIG. 4 illustrates an example path building algorithm that can be performed at the beginning of each time window, according to this disclosure;

FIG. 5 illustrates examples of Markov chains that model available network bandwidth;

FIGS. 6A through 6D illustrate example results of simulations according to this disclosure;

FIGS. 7A and 7B illustrate a comparison of bitrate selections according to this disclosure;

FIG. 8 illustrates a method for adaptive video streaming according to this disclosure; and

FIG. 9 illustrates a general-purpose network component suitable for implementing one or more embodiments disclosed herein.

### DETAILED DESCRIPTION

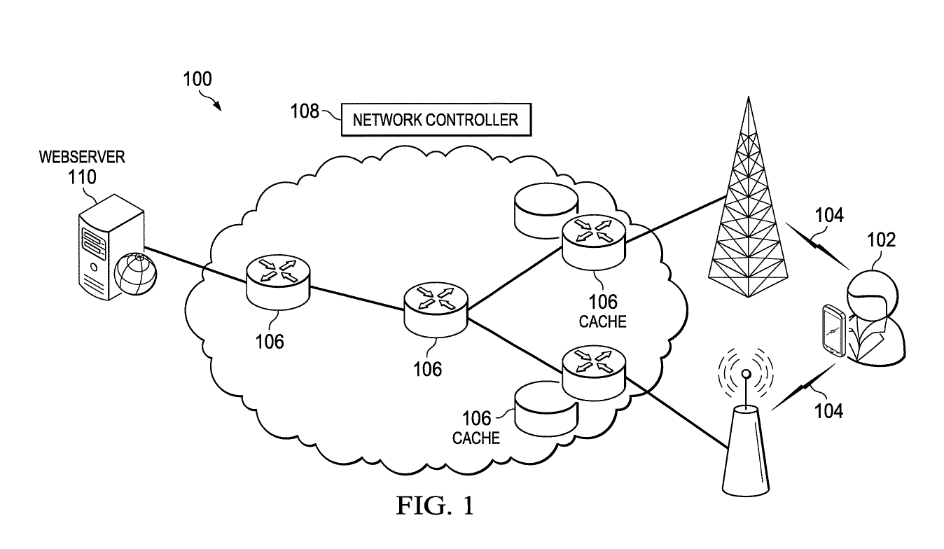

FIGS. 1 through 9, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

Embodiments of this disclosure provide a cache-aware content-based rate adaptation mechanism for adaptive video streaming. In particular, the disclosed embodiments provide a novel infrastructural approach for controlling the peak load on the network over time for clients with quickly changing available capacity, while maintaining a high quality experience for end users. The experience is defined as a set of quality metrics, such as average bitrate, temporal variability, and an amount of rebuffering time. The disclosed embodiments are based on a number of key concepts, including: (1) the predictability of future user requests of video portions to preemptively plan delivery to a cache located at the edge network, and (2) future knowledge of available infrastructural resources at the core and edge wireless network to better distribute the load on the network of the video streams and control the Quality of Experience (QoE) for the end user.

Video streams are typically predictable, long-living flows of data. Moreover, the surge of technologies, such as Dynamic Adaptive Streaming over HTTP (DASH) and other equivalents (Apple HLS, Adobe HDS, etc.), provide additional levels of predictability due to one specific property: DASH video streams are typically fully described in a manifest exchanged by the involved parties at the instantiation of the communication, which makes them predictable in the sense that the sequence of packets is predetermined by the video stream's description and the network conditions. To exploit this predictability, the network should be aware of the requests sent by the video clients. Knowledge of user requests is available natively in Information-Centric Networking (ICN) architectures, which employ a receiver-driven model where receivers request contents by their name from one or more publishers. Combining these two technologies leads to the following observation: in an ICN, it is easier for the edge network to infer what a user is streaming, and to derive what the user will request if the user continues to watch the video stream.

Future knowledge of available infrastructural resources is possible when the user's future location is known, which can in turn be used to infer the user's future wireless coverage or capacity. For example, this is the case for users on public transportation (e.g., buses, trains), or for users using navigation systems in their cars. In fact, even without prior knowledge of vehicle routes, one can still infer future vehicle mobility. For example, research has demonstrated the effectiveness on real data of K Nearest Trajectories in an algorithm to predict future capacity variations for vehicles. More generally, human mobility patterns tend to be highly predictable. Research has shown a potential 93% average predictability, which suggests that predicting future patterns is quite reasonable. Future knowledge of available infrastructural resources has been extensively analyzed in the past, especially in two main categories: location and pattern based, and resource based. This disclosure does not exclude a more proactive approach of resource management, where service providers might want to proactively allocate resources to the clients.

Dynamic Adaptive Streaming over HTTP (DASH) is a standard for video streaming that has been widely deployed by many major video streaming services such as NETFLIX, HULU, and YOUTUBE. In DASH, video content is broken into a sequence of small segments, each containing a short playback time of the video. The DASH client first requests a manifest (e.g., the media presentation description, or “MPD”) describing the video and available quality levels, and then adaptively requests the segment with proper video quality based on the current network conditions reflected during the streaming process.

Information-Centric Network (ICN) architectures have been proposed recently to allow the network to be aware of content semantics. DASH over ICN has been attracting some attention, with some research examining the interaction of DASH with ICN. Other research targets HTTP adaptive streaming (HAS) in Content-Centric Networking (CCN) for Scalable Video Coding.

Some studies examine how to predict video requests from users by looking at social interactions. This disclosure uses the natural predictability that video streaming offers. Other studies describe a web prefetching module running on the content distribution network (CDN) main node (e.g., controller), which downloads web contents that will be requested in the future to the LAN CDN surrogates. The embodiments disclosed herein are different, because the time domain is much smaller and the prefetching utilizes the bandwidth more dynamically.

Research has demonstrated potential benefits of CDN augmentation strategies that can offer Internet video workloads using a dataset of 30 million video on demand (VoD) and live sessions. It has also been observed that fractions of viewers typically watch only the first 10 minutes of video, around 4.5% of users are serial early quitters, and 16.6% of users consistently watch video to completion. This suggests that a user based prefetching policy should be a natural extension for this disclosure.

Some studies propose a Network-Friendly DASH (NF-DASH) architecture for coordinating peer-assisted CDNs operated by ISPs and the traditional CDNs. Other studies analyze the waiting time and network utilization with service prioritization, considering both on-demand fetching/caching and prefetching in a peer-to-peer (P2P) assisted video streaming system. Some studies formulate the CDN assignment as an optimization problem targeting minimizing the cost based on the QoE constraints to CDN servers at different locations. Other research shows by measurement the shortcomings of today's video delivery infrastructure and proposes a control plane in the network for video distribution for global resource optimization.

Hybrid P2P-CDN video streaming enhancement (i.e., serving content from dedicated CDN servers using P2P technology) has also been considered. Telco-CDN federation (CDNs operated by telecommunication companies, enabling users to reach CDN caches that are closer) is an emerging strategy. Telco-CDN federation can reduce provisioning costs by 95%. Using P2P can lead up to 87.5% bandwidth savings for the CDN during peak access hours.

Proxy-assisted caching and prefetching has been widely studied in the literature. Some approaches consider the quality of the connections and the usage of the client buffers. Approaches for transcoding proxy caching include the proxy caching different versions of the content to handle the heterogeneous user requirements. Prefix caching caches only the frames at the beginning to minimize the average initial delay. Exponential segmentation divides the video object such that the beginning of a video is cached as a smaller segment. The so-called “lazy segmentation” approach determines the segment length according to the user access record at the late time.

Prefetching is common for video content to reduce the pause time during playback and service delay. In one scheme, a server predicts the links that will be requested and prefetches accordingly. The use of proxy prefetching in VoD systems has been intensively studied. For example, some research provides a segment-based proxy pre-fetching for streaming delivery. Other research evaluates the 1-ahead, n-ahead, and priority-based segment prefetching. The results show that if the bottleneck link is between client and proxy, all prefetching schemes achieve a high cache hit rate after two or three clients requesting a video. On the other hand, if the bottleneck link is between the proxy and server, prefetching does not seem to help. This disclosure considers the link between the cache and the server and makes a prefetching decision accordingly.

Network Model and Architecture

Information Centric Networks build their core features on two fundamental elements: (1) named content retrieval as a network primitive, and (2) extended availability of in-network caches to support delivery of these contents. The embodiments disclosed herein build on these concepts.

FIG. 1 illustrates an example of an information centric network 100 according to this disclosure. As shown in FIG. 1, one or more mobile devices 102 are connected to the network 100 through multiple interfaces 104 based on different technologies (hence, with different performance and availability over time). The mobile devices 102 act as clients that request and receive the content. Multiple caches 106 are available in the network 100 and are strategically positioned to be close to the edge networks. A network controller 108 serves as an orchestration system, and has knowledge of the content requests issued by the clients 102 and the resources available in the caches 106 and has the ability to request the caches 106 to prefetch contents and have them available for future delivery. Depending on the embodiment, the network controller 108 could be centralized or distributed.

Embodiments of this disclosure, such as the network 100, can utilize the recently standardized DASH protocol. In this protocol, each video file is divided in segments of equal duration encoded at different bitrates and stored in a web server 110. A client interested in retrieving the video first retrieves a Media Presentation Description file that contains information of the structure of the video and the available different bitrates. By inspection of content requests, the network controller 108 can intercept the requests of this description files and maintain a detailed view of the current active video streams. Moreover, by tracking the progress of the requested segments, the network controller 108 maintains a complete vision of the video buffers available at each client. This disclosure assumes that the network controller 108 has access to a general view of the network infrastructure resources available both in the core network and at the edge network. It is possible to predict to a certain extent the variability of a user's connectivity in wireless networks by either exploiting movement predictability or by recognizing performance patterns. Hence, this disclosure assumes that the network controller 108 has access to this information.

System Architecture

With the presented infrastructure, embodiments of this disclosure provide a solution that integrates all the given components with the goal of minimizing the load on the network while maximizing the Quality of Experience for the end users. As indicated above, embodiments of this disclosure use a centralized network controller (e.g., the network controller 108) that orchestrates the necessary operations. Of course a centralized controller architecture is merely one example. Other embodiments of this disclosure can obtain the same results with a distributed control architecture. The protocol of this architecture relies on tracking and exploiting available in-network resources (e.g., capacity and caches).

Stream Initialization

In order to initialize the streaming process, each client requests the DASH MPD file from the server. The controller captures these requests and retrieves the same information by deep packet inspection of the returned content or by requesting the same file from the web server. With this information, the controller obtains a complete view of the video that will be retrieved. To simplify the description and notation, this disclosure assumes that each video is composed of N segments sᵢ:

sᵢ^{N}={s₁,s₂, . . . ,s_{N}}

where each segment has duration S seconds and is available at M different bitrates.

Bitrate Adaptation

Once the MPD file is retrieved, the client can proceed to sequentially request the segments. While in a normal DASH setup, the client would be in charge of selecting one of the available bitrates for each requested segment, embodiments of this disclosure leave this responsibility to the controller. This arrangement is justifiable by considering the fact that the controller has the best possible view of the available resources, by accessing infrastructure components and tracking the client process through its issued requests. The controller selects among the different bitrates based on two main factors: status of the video reproduction at the client (i.e., buffer size and previous quality selection) and future availability of infrastructure resources. In particular, this disclosure assumes that the controller has access to information regarding residual capacity available in the network and bandwidth for any specific client for a time window of size T seconds.

Streaming Process

In order to meet the goals described above, the controller divides the delivery path into two components: from the server to the local caches available at the edge network, and from the caches to the client over the wireless link. The controller uses the available information in the time slot of size T seconds to provide in-time delivery to the caches and serve requests directly from them. In order to do so, it introduces a delay of δ seconds, which is used as a cushion to transfer segments to the edge while smoothing the traffic load overtime. The size of the window δ is carefully selected, since a large value would introduce an excessive delay in the start of the video reproduction (reducing the quality of the experience for the client) and a small value would minimize the gains obtained. Additional details regarding the involved algorithms are provided below.

Quality of Experience Model

Many different Quality of Experience (QoE) models have been proposed in the past in order to quantify user satisfaction. What makes this problem so difficult to formalize is the nature of the metric, which is heavily dependent on different user perspective. The following key factors are widely accepted as playing an active role in defining the QoE for video streaming:

Average quality (mean bitrate): Multiple studies have suggested that the average video quality should not be used as the sole metric in determining the quality experienced by a user. Nevertheless, a way of factoring the proportional quality between different available bitrates is needed. For this reason, this disclosure accepts that there is a direct relationship between bitrate selection and quality governed by logarithmic laws.

Temporal quality variance (rate oscillations): Different studies have shown how representation switching can factor negatively against the quality of experience. In particular, one study found that only up to 0.5 quality switches per minute is considerable tolerable by users; higher switch rates likely cause an exponential increase in rate of abandonment. Moreover, human memory effects can distort quality ratings if noticeable impairments occur in approximately the last 10-15 seconds of the sequence, exponentially decaying afterward, thereby causing past factors to relatively influence the current visualized video.

Buffering time and ratio (video freeze): It has been widely demonstrated that frequency and length of video rebuffering highly affects the perceived quality of a video stream, where each event increases the rate of abandonment and reduces the probability of client return. Buffering is not considered initially, because rebuffering is introduced by errors in selecting the rate, not by lack of available bandwidth. This disclosure assumes that minimal bandwidth for the lower bitrate is always guaranteed.

This disclosure describes the first two points (average quality and temporal quality variance) in defining a model of the quality of experience perceived by a client over a video session. Of course, the QoE model may take additional parameters (e.g., bandwidth cost, storage cost, and the like) into account as well. First, this disclosure expresses the quality of a video segment following a concave utility function q(•). One specific embodiment would use the logarithmic law:

q(rᵢ,r)=α ln(βrᵢ/r) (1)

where r is the minimum quality available for the segment, rᵢ is the quality of the considered segment i, and α and β are specific factors that vary depending on the type of the displayed content. However, this disclosure does not restrict which utility function can be used as an input to define the utility of a rate increase.

Taking into consideration the second factor, this disclosure defines a temporal quality variance penalty for two following video segments selected at qualities q₁(rᵢ,r) and q₂(rⱼ,r) as v such that v(q) is increasing and v(0)=0. One possible such function could be:

vᵢ=η(qᵢ−qᵢ₋₁), if qᵢ≧qᵢ₋₁,

vᵢ=−γ(qᵢ−qᵢ₋₁), if qᵢ<qᵢ₋₁, (2)

where η and γ are positive factors that determine how much changes impact the overall experience when a transition to a higher quality or lower quality representation occurs. However, this disclosure does not restrict the variance penalty to that of Equation (2).

This disclosure formulates a QoE model as a utility function capturing the defined values, where for a sequence of N segments selected at qualities q₁^{N}:

Φ(q₁^{N})=Σₖ₌₁^{N}(qₖ−vₖ) (3)

where vₖ=v(q_{k-M}^{k}). The utility function could also include other considerations that are not described in this disclosure, but that a person skilled in the art could add, including a buffer occupancy cost, a delay penalty cost, and the like.

Rate and Streaming Algorithms

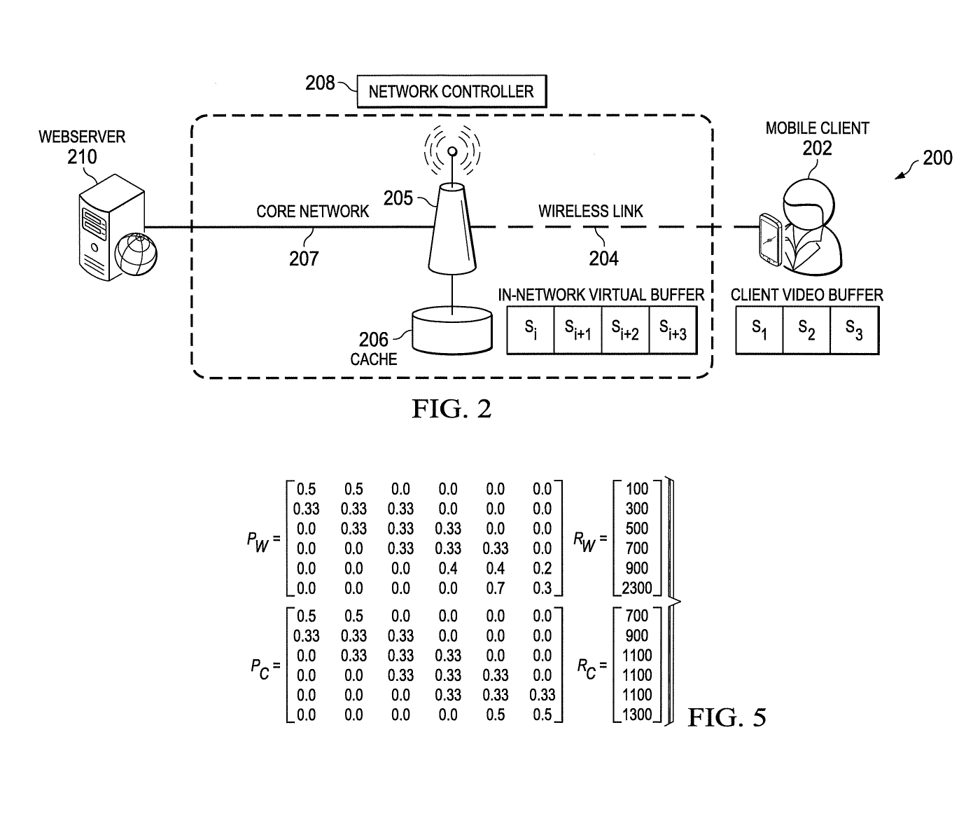

FIG. 2 illustrates an example of an information centric network 200 for use with the rate and streaming algorithms according to this disclosure. As shown in FIG. 2, the network 200 includes a mobile client 202, an intermediate node 205, one or more caches 206, a network controller 208, and a web server 210. The web server 210 has complete availability of all the segments composing a requested video. The intermediate node 205 includes (or represents) the set of caches 206 used to support the streaming process. The intermediate node 205 performs a number of functions, including caching of popular content and store-and-forward streaming optimization for content that is not cached locally. This is achieved by monitoring communication links 204, 207 over time, as described below.

The mobile client 202 communicates with the network 200 through one or more wireless links 204. This disclosure considers only the joint capacity of all the wireless links 204 that the client 202 uses to connect to the network 200. The wireless links 204 can also be referred to as the edge network. The web server 210 communicates with the intermediate node 205 where the caches 206 are located over a wired or wireless link 207. The link 207 can also be referred to as the core network. Resources available on the links 204, 207 are regulated by the available capacity or bandwidth in the network 200 for the links 204, 207. The available capacity of the edge network 204 over time can be represented by a function e(t), while the available capacity of the core network 207 over time can be represented by a function c(t). In order to better describe the algorithms disclosed herein, embodiments of this disclosure model a system as a sequence of three nodes: the web server 210, the intermediate node 205, and the mobile client 202.

Before going into the details of the algorithm, a supporting example of adaptive video streaming will now be provided that may promote understanding of the presented model. In contrast to current solutions where the logic employed to perform the bitrate adaptation process is based on estimation of available resources perceived in the recent past, this disclosure considers a partially anticipative case in which a finite window of future edge and core network capacity variations are known beforehand. This information is used by the network controller 208 to schedule which video segments to download in the upcoming future, by either transferring directly the content from the web server 210 to the client 202, or by using the available caches 206 as support.

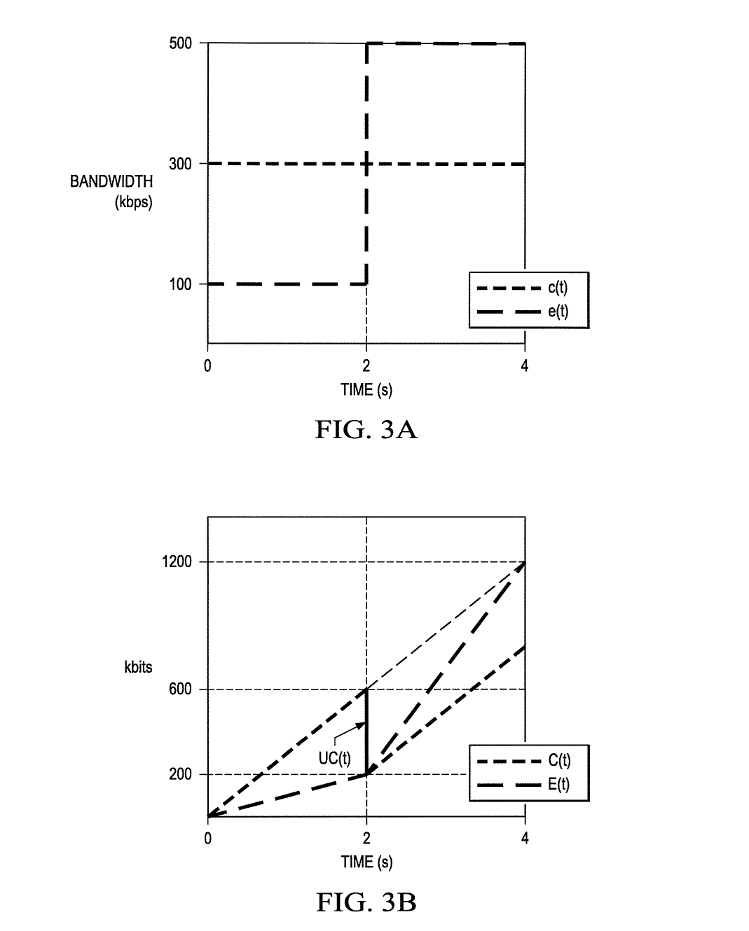

Assume that at time t, the evolution of the available capacities are c_{[t,t+W]} and e_{[t,t+W]}, where W is the future knowledge window size, and the capacity beyond t+W is not known. FIG. 3A illustrates a simple scenario, where W=4 seconds, c(t) is constant at 300 kbps and e(t) varies from a first two-second period at 100 kbps to a second period at 500 kbps. In this context, a client wants to retrieve a video divided in segments of size 2 seconds and available at three different representations: low resolution (100 kbps), medium resolution (300 kbps) and high resolution (600 kbps).

Initially, the video buffer is empty, so assume that the first segment of video is downloaded at minimum quality to reduce the startup wait time for the client. This corresponds to downloading 200kbits of data which, in this example, given the initial bottleneck of the edge network wireless link, will take two seconds to complete. Once this happens, the video client has two seconds of video available for display. The client should try to download the next segment within this amount of time, otherwise a rebuffering event would occur (i.e., the video client remains stuck waiting for more video data to be available). Let the amount of time until the moment the next downloaded segment will be displayed be referred to as the download deadline time, or t_{d}. The time t_{d} in this example will then occur at the time of 4 seconds. In the context of this example, where downloads are controlled by the client, only two video representations would meet the deadline: 100 kbps (which would allow for more segments to be downloaded) and 300 kbps.

In an anticipative case, it is known that even though the first download is bandwidth limited by the current bottleneck, the network resources are underutilized, since 200 kbps of unused capacity are not exploited during the first segment download. By scheduling downloads in advance, while evaluating the amount of time needed to download the next segment, embodiments of this disclosure consider the unused capacity as data that might actually have been downloaded to the local caches. The actual amount of data that could have been downloaded to a location in the network (i.e., the caches) is easily calculated from the cumulative versions of e(t) and c(t), called E(t) and C(t), as:

UC(t)=C(t)−E(t).

FIG. 3B illustrates the cumulative downloaded data of FIG. 3A. In FIG. 3B, UC(t) is indicated by the arrow and corresponds to 400kbits at t=2 seconds. It can be assumed that this amount of data could already have been transferred close to the edge network, thus preventing the core network from being the bottleneck in the second period. This difference can be seen in FIG. 3B: given that the amount of downloaded data always corresponds to the minimum of the two functions E(t) and C(t) (as a client can never download more than what is allowed by the bottleneck in the network), at the time of 2 seconds this would correspond to 200kbits. Assuming no preemptive caching is applied, the amount of data that could be downloaded in the second period is again delimited by the minimum of the two lines, and in this case, it would correspond to the line representing C(t). If it is assumed that the core network has moved to the caches an amount of data corresponding to the unused capacity, the minimum has now to be taken between E(t) and the dotted version of C(t).

The algorithm described herein applies these concepts of deadlines and evaluations of unused capacity to explore the state space of valid combinations of segment bitrate downloads to select the one in the time window that produces the highest QoE utility function value without resulting in rebuffering events (hence always meeting the set deadlines).

Bitrate Selection Algorithm

The video streaming process can be defined as a combination of two tasks for each window of future knowledge. First, the controller schedules one or more segment downloads given the available predicted resources and the client reproduction status. Second, the segments are delivered to the mobile hosts with use of the edge caches. The core of the bitrate selection algorithm is based on a recursive path building algorithm or function performed at the beginning of each time window.

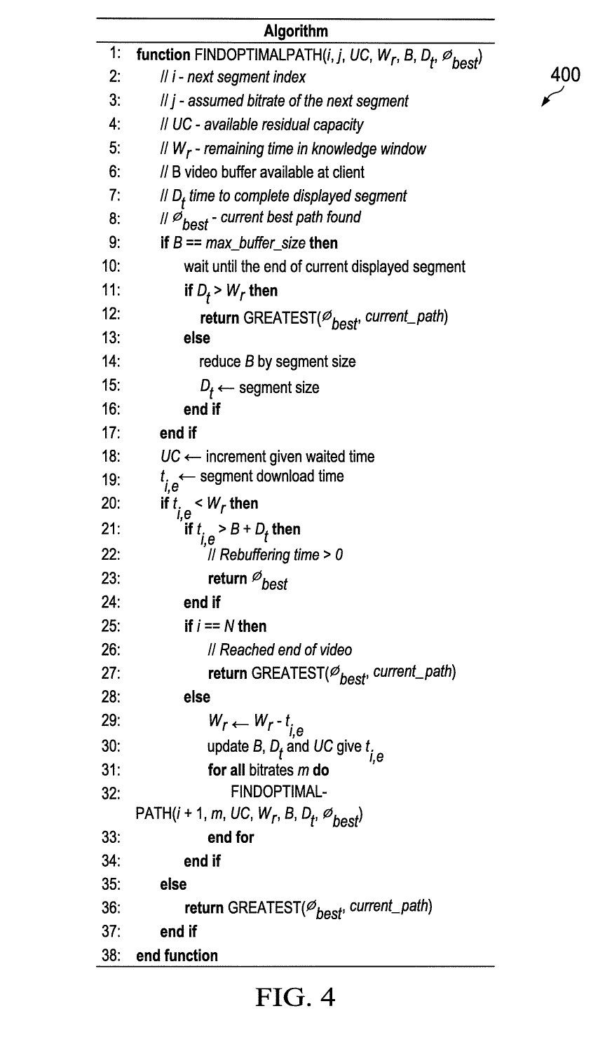

FIG. 4 illustrates an example path building algorithm 400 that can be performed at the beginning of each time window, according to this disclosure. The algorithm 400 can be performed by one or more components of the network 200, such as the intermediate node 205 or the network controller 208. The algorithm 400 searches for an optimal rate path (i.e., a sequence of segment bitrates, such as shown in FIG. 3A) among all possible combinations. That is, the algorithm 400 computes potential rate paths that are achievable under the estimated rate horizon, and selects the one that maximizes the QoE utility function.

Starting from time t and given a potential bitrate j for the next required segment with index i, the algorithm 400 determines the effect of such representation on the download process. Once it has consumed the entire future knowledge window, the algorithm 400 determines the QoE of the selected path. The algorithm 400 calculates the download time for the given segment using the available throughput and residual capacity from previous steps.

Each time the algorithm 400 is called from the base bitrate selection algorithm, the starting residual capacity is assumed to be zero. In recursive calls, the residual capacity in the core network, if available according to the known cumulative throughput functions C(t) and E(t), may be adjusted. As long as the knowledge window limit is not reached, the recursion follows. Once the end of the window (or potentially the end of the video) is reached, the QoE utility function value of the current path is calculated and compared with the best path previously found; only the better of the two is kept. In case a rebuffering time event is detected, the path is declared invalid and the function returns.

The algorithm 400 can be summarized in four main steps:

1) Avoid overrunning the client buffer by waiting until some space is created (lines 9 to 17 of algorithm 400).

2) Calculate the download deadline for the considered segment (t_{i,d}) and evaluate the given previously accumulated unused capacity if the deadline can be met by calculating the amount of time necessary to transfer the required data (t_{i,e}); if the deadline cannot be met, return the previously found best path (lines 18 to 24).

3) If the future window has been consumed or the end of the file is reached, return the GREATEST utility value between the utility value of the current path and the utility value of the previously best path (lines 25 to 27 and lines 35 to 37).

4) Otherwise, recursively evaluate the same function for the next segment (index i+1) over its possible representations (lines 28 to 34).

After completing the recursive process, the sequence of segments with the highest QoE value is returned and the controller can use it to instruct the other network components on how to proceed (i.e., instruct the clients and the caches on how to proceed for downloading the selected segments). In some embodiments, different coefficients can be selected for the algorithm 400 in order to favor the QoE versus operator costs.

Interleaving Windows

One characteristic of the algorithm 400 is that it tries to use as many resources as are available in the time window without much consideration for the following time slots. Since the QoE cost of switching to a higher bitrate is lower than the cost of switching to lower bitrates, the consequence of such behavior is the tendency to select higher bitrates toward the end of the window to consume the remaining capacity available. In some embodiments, this may not always be the optimal path in the long run, since it might be necessary to choose a lower bitrate at the beginning of the next time window, and thus cause a QoE drop due to switching to a lower bitrate immediately afterwards. To avoid this issue, another embodiment is available. While this embodiment still applies the same algorithm for the complete window of size W to select the best path, this embodiment only applies the obtained optimal path until an earlier moment W−tᵢ, where tᵢ is smaller than W. In this embodiment, the algorithm prevents a higher bitrate from being selected in the last tᵢ of the time window W, avoiding possible quality drops at the beginning of the next window. After this is done, the new considered window will start from time W−tᵢ.

Cost Analysis

The cost of the algorithm can be exponential if the bandwidth that is considered is always bigger than video bitrate (i.e., all possible representations could be downloaded). A number of simple measures and considerations can be made to result in an effectively lesser actual cost in real deployments: (1) As quality transitions (in particular negative ones) negatively affect the final utility value, a limit is set on the number of these events. (2) If the bottleneck bandwidth is always higher than a certain bitrate during the duration of a time window, all video representations with lower bitrate can be left out of consideration. (3) In most cases, the total number of downloaded segments will be limited as the window size is limited.

Simulations

A set of MATLAB based simulations illustrate the gains that can be achieved using embodiments of the disclosed system, including the network 200 and the algorithm 400. In order to understand its potential, the core logic of the disclosed system is implemented and the results are compared to the behavior of common DASH implementations. While different proprietary algorithms are used in some of the available commercial solutions (e.g. APPLE HLS, ADOBE HDS, etc.), the baseline is implemented following the logic implemented by NETFLIX-like video services, which can be summarized as having the following two main characteristics:

(1) The DASH client downloads and keeps only video segments for the following t seconds of playback at any given time (i.e., the buffer size is limited by time, not data space).

(2) The DASH client logic adapts video quality by a moving average of the data rate estimates experienced on the previous k segments delivered (the value of k is set to 5 for the MATLAB simulations described below).

While it is easy to identify a wide selection of factors that might affect the final results of the simulations, the baseline is fairly compared with the two variants of the algorithm 400 by applying for each run the same conditions (i.e., evolution of network infrastructure resources during the simulation time). The next two sections describe the model used to characterize these resources and the video data set employed in the MATLAB simulation tests.

System Resources and Network Model

The disclosed simulations do not take into consideration the availability of video segments at different servers; the simulations use a single server that always has the desired video content available at all times. Moreover, the simulations do not consider any limit in the cache size of the intermediate nodes. The available network bandwidth is modeled as two finite-state, discrete-time Markov chains, where transitions occur at constant times, every 2 seconds, and transitions occur only between the two nearest states. This is done to try to capture slow variations attributable to client mobility (for the wireless links) and evolution in congestion for the core network. FIG. 5 illustrates examples of these Markov chains, where P_{W} represents the transition matrix for the wireless access network, where for each state the corresponding bandwidth is shown in R_{W} (expressed in kbps). The same values are shown for the core network in P_{C} and R_{C}.

Video Dataset and QoE Model

For the disclosed simulations, a video content of 5 minutes of length is used. The video is divided into two-second segments, with each segment available in three different bitrate representations (1 mbps, 400 kbps, and 100 kbps). While the disclosed embodiments support variable bitrates for the video segments, these simulations only use constant bitrates (i.e., all segments at the same quality level have the same size). The Quality of Experience is calculated using Equations (1) through (3) described above with parameters α=1, β=1, γ=1, and η=0.1.

Results

The disclosed system is evaluated under two varying factors: video buffer size available at the DASH client and the window of future knowledge of available bandwidth at the two analyzed network components.

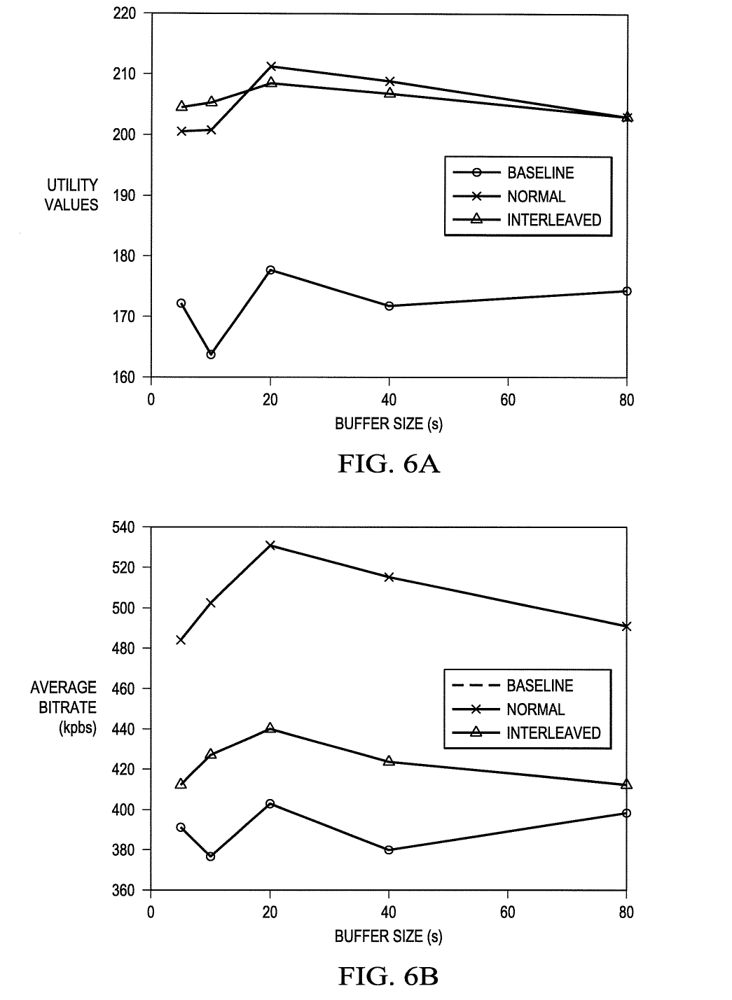

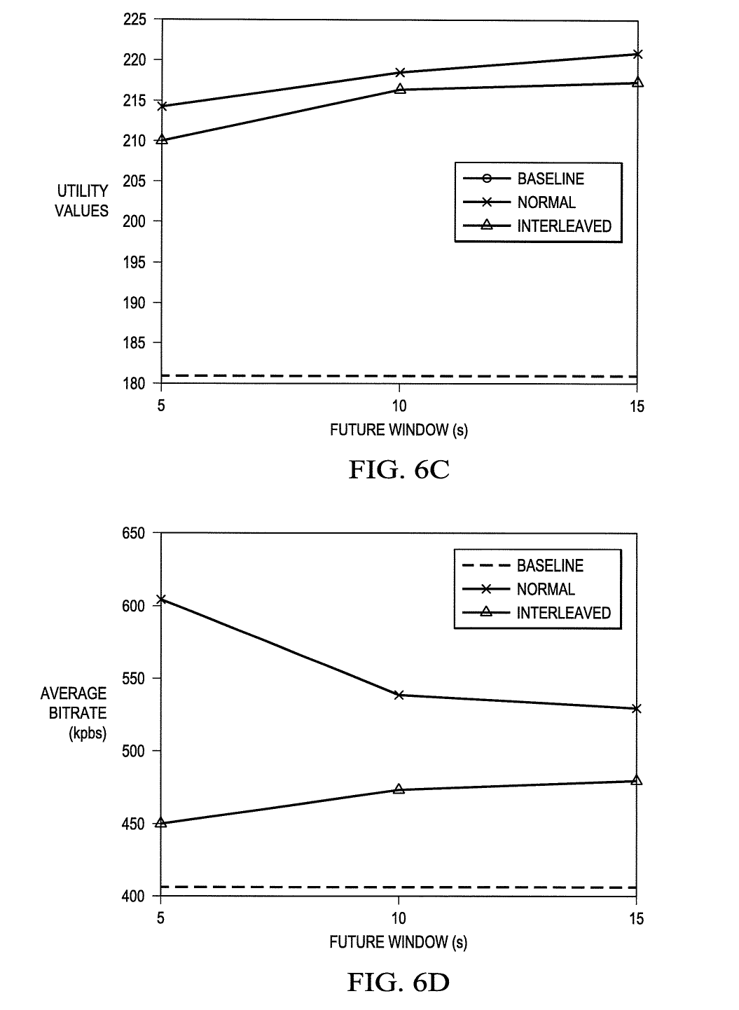

FIGS. 6A through 6D illustrate example results of the simulations according to this disclosure. FIG. 6A illustrates the utility value with varying buffer size. FIG. 6B illustrates the average bitrate with varying buffer size. FIG. 6C illustrates the utility value with varying future window size. FIG. 6D illustrates the average bitrate with varying future window size. In each figure, the Baseline plot represents conventional algorithms, while the Normal and Interleaved plots represent the disclosed algorithm and its interleaving windows embodiment, respectively.

For each of the data points represented, the simulation was repeated five times and the average result was collected. This does not apply for the baseline in FIGS. 6C and 6D, since the future window size can vary only for the disclosed algorithms. For these cases, a single data point was used using a client buffer size of twenty seconds. In general, the results confirm the overall benefit of the disclosed embodiments, with gains of at least fifteen percentage points in the utility value for both disclosed algorithm embodiments (normal and interleaved). This not only corresponds to a more stable experience (as variations, in particular decreases in quality, strongly affect the final QoE value), but also in a higher average bitrate quality for all the simulations analyzed.

The buffer size available for the clients is not a significant influencing factor for the analyzed use case, as neither algorithm uses the buffer size information to modify its adaptation logic. This parameter may gain more importance for longer videos, where a low bandwidth period might be better compensated by the accumulated buffer. More interestingly, it can be noticed that even with increased knowledge (i.e., a bigger future knowledge window), the gains achieved by this system might not justify the additional computational cost.

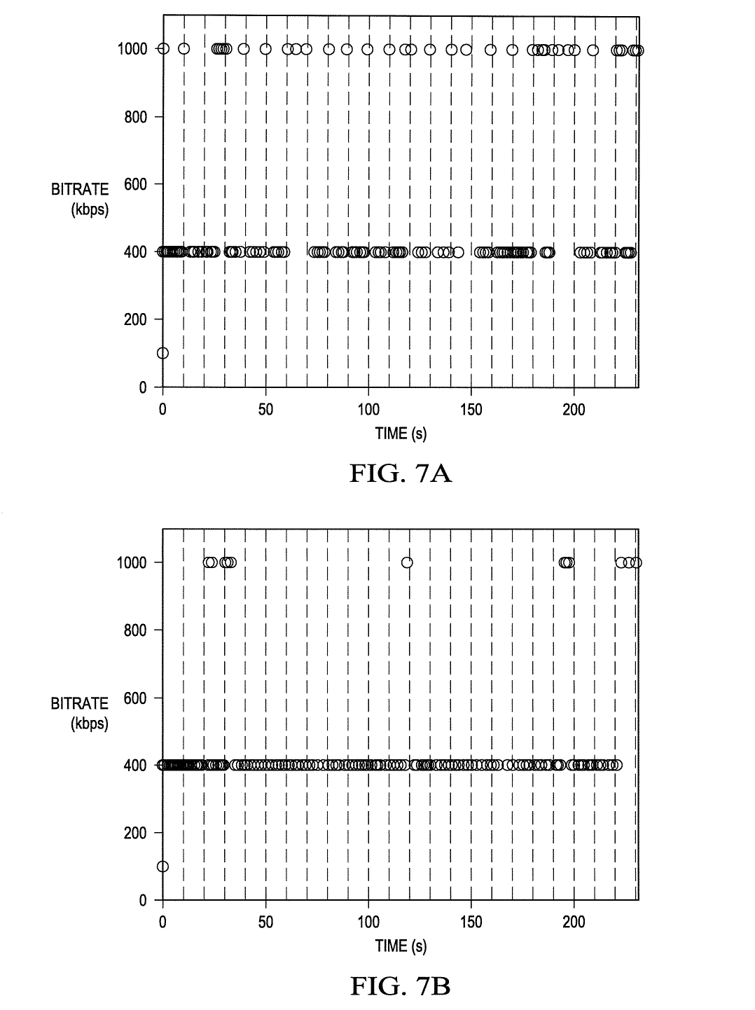

Finally, the results were obtained using conservative values for the QoE factors γ and η, where quality transitions, especially the ones that imply an improvement in bitrate, are not hardly punished. This is particularly true in comparing the two presented algorithms, where the base algorithm tries to aggressively transition to a higher quality at the end of the knowledge window. This behavior is captured in the comparison between FIGS. 7A and 7B, which represent the bitrates selected by the two algorithms in one of the runs with a buffer size of twenty seconds and a window size of ten seconds.

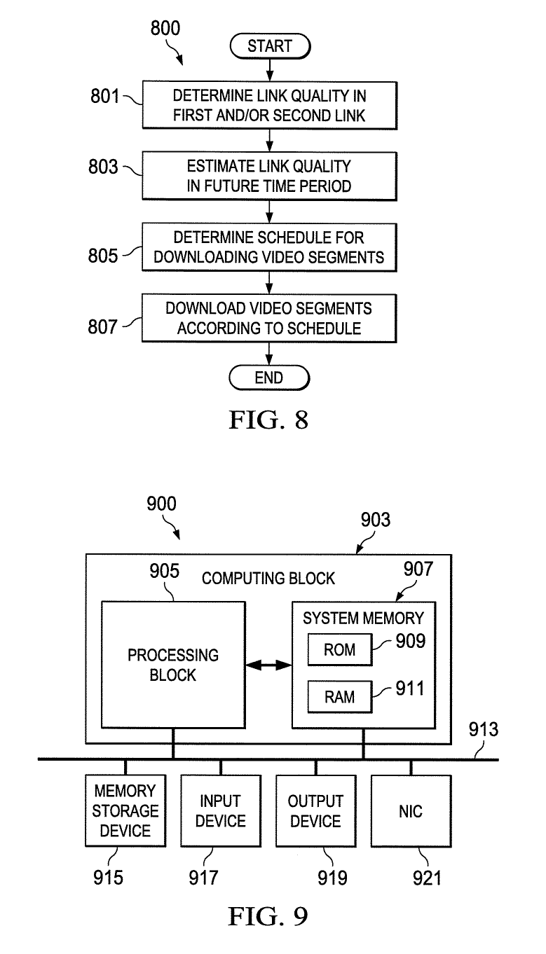

FIG. 8 illustrates a method for adaptive video streaming according to this disclosure. The method 800 shown in FIG. 8 is based on the key concepts described above. The method 800 may be performed by one of the components of FIG. 2 (e.g., the intermediate node 205 or the network controller 208) or the network component 900 of FIG. 9, described below. However, the method 800 could also be used with any other suitable device or system.

At operation 801, a link quality or throughput is determined in a first link from a server to an intermediate node, in a second link from the intermediate node to a client device, or in both links. This may include the network controller 208 determining a link quality or throughput in the one or both links 204, 207.

At operation 803, based on the determined link quality or throughput, a link quality in a future time period is estimated the first link, the second link, or both. This may include the network controller 208 estimating a link quality in a time window from time t to time t+W, such as described with respect to FIGS. 3A and 3B.

At operation 805, a schedule is determined for downloading video segments from the server to a cache associated with the intermediate node, where the schedule is determined based on the estimated link quality in the future time period. This may include the network controller 208 determining a schedule for downloading video segments from the web server 210 to the cache 206. The schedule is determined using an algorithm that optimizes a quality of experience (QoE) for the client device. For example, the schedule may be determined using the algorithm 400 or a similar algorithm.

At operation 807, one or more video segments are downloaded according to the schedule from the server to the cache during the future time period, in order to make the video segments available in the cache for transmission to the client device. This may include the network controller 208 controlling the download of video segments from the web server 210 to the cache 206 during the time period from time t to time t+W.

Although FIG. 8 illustrates one example of a method 800 for adaptive video streaming, various changes may be made to FIG. 8. For example, while shown as a series of steps, various steps shown in FIG. 8 could overlap, occur in parallel, occur in a different order, or occur multiple times. Moreover, some steps could be combined or removed and additional steps could be added according to particular needs.

The network components described above may be implemented on any general-purpose network component, such as a computer or network component with sufficient processing power, memory resources, and network throughput capability to handle the necessary workload placed upon it. FIG. 9 illustrates a typical, general-purpose network component 900 suitable for implementing one or more embodiments disclosed herein. The network component 900 includes a computing block 903 with a processing unit 905 and a system memory 907. The processing unit 905 may be any type of programmable electronic device for executing software instructions, but will conventionally be one or more microprocessors. The system memory 907 may include both a read-only memory (ROM) 909 and a random access memory (RAM) 911. As will be appreciated by those of skill in the art, both the read-only memory 909 and the random access memory 911 may store software instructions for execution by the processing unit 905.

The processing unit 905 and the system memory 907 are connected, either directly or indirectly, through a bus 913 or alternate communication structure, to one or more peripheral devices. For example, the processing unit 905 or the system memory 907 may be directly or indirectly connected to one or more additional memory storage devices 915. The memory storage devices 915 may include, for example, a “hard” magnetic disk drive, a solid state disk drive, an optical disk drive, and a removable disk drive. The processing unit 905 and the system memory 907 also may be directly or indirectly connected to one or more input devices 917 and one or more output devices 919. The input devices 917 may include, for example, a keyboard, a pointing device (such as a mouse, touchpad, stylus, trackball, or joystick), a touch screen, a scanner, a camera, and a microphone. The output devices 919 may include, for example, a display device, a printer and speakers. Such a display device may be configured to display video images. With various examples of the network component 900, one or more of the peripheral devices 915-919 may be internally housed with the computing block 903. Alternately, one or more of the peripheral devices 915-919 may be external to the housing for the computing block 903 and connected to the bus 913 through, for example, a Universal Serial Bus (USB) connection or a digital visual interface (DVI) connection.

With some implementations, the computing block 903 may also be directly or indirectly connected to one or more network interfaces cards (NIC) 921, for communicating with other devices making up a network. The network interface cards 921 translate data and control signals from the computing block 903 into network messages according to one or more communication protocols, such as the transmission control protocol (TCP) and the Internet protocol (IP). Also, the network interface cards 921 may employ any suitable connection agent (or combination of agents) for connecting to a network, including, for example, a wireless transceiver, a modem, or an Ethernet connection.

It should be appreciated that the network component 900 is illustrated as an example only, and it not intended to be limiting. Various embodiments of this disclosure may be implemented using one or more computing devices that include the components of the network component 900 illustrated in FIG. 9, or which include an alternate combination of components, including components that are not shown in FIG. 9. For example, various embodiments may be implemented using a multi-processor computer, a plurality of single and/or multiprocessor computers arranged into a network, or some combination of both.

In some embodiments, some or all of the functions or processes of the one or more of the devices are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for adaptive video streaming, the method comprising:
determining a link quality or throughput in at least one of: a first link from a server to an intermediate node or a second link from the intermediate node to a client device;
based on the determined link quality or throughput, estimating a link quality in a future time period for at least one of: the first link or the second link;
determining a schedule for downloading video segments from the server to a cache associated with the intermediate node, the schedule determined based on the estimated link quality in the future time period; and
downloading video segments according to the schedule from the server to the cache during the future time period, in order to make the video segments available in the cache for transmission to the client device.

2. The method of claim 1, wherein the schedule comprises at least one transmission bitrate for downloading the video segments.

3. The method of claim 1, wherein the schedule is determined using an algorithm that optimizes a quality of experience (QoE) for the client device.

4. The method of claim 3, wherein the algorithm determines a plurality of potential schedules that are achievable in the future time period, and selects the schedule that optimizes the QoE for the client device.

5. The method of claim 4, wherein the QoE is defined as a set of quality metrics, including an average bitrate and a temporal variability.

6. The method of claim 1, wherein the video segments are downloaded according to the schedule from the server to the cache during only a first portion of the future time period.

7. The method of claim 1, wherein the client device comprises a wireless mobile device.

8. An apparatus for adaptive video streaming, the apparatus comprising:
at least one memory; and
at least one processor coupled to the at least one memory, the at least one processor configured to:
determine a link quality or throughput in at least one of: a first link from a server to an intermediate node or a second link from the intermediate node to a client device;
based on the determined link quality or throughput, estimate a link quality in a future time period for at least one of: the first link or the second link;
determine a schedule for downloading video segments from the server to a cache associated with the intermediate node, the schedule determined based on the estimated link quality in the future time period; and
download video segments according to the schedule from the server to the cache during the future time period, in order to make the video segments available in the cache for transmission to the client device.

9. The apparatus of claim 8, wherein the schedule comprises at least one transmission bitrate for downloading the video segments.

10. The apparatus of claim 8, wherein the at least one processor is configured to determine the schedule using an algorithm that optimizes a quality of experience (QoE) for the client device.

11. The apparatus of claim 10, wherein the at least one processor is configured to use the algorithm to determine a plurality of potential schedules that are achievable in the future time period, and selects the schedule that optimizes the QoE for the client device.

12. The apparatus of claim 11, wherein the QoE is defined as a set of quality metrics, including an average bitrate and a temporal variability.

13. The apparatus of claim 8, wherein the video segments are downloaded according to the schedule from the server to the cache during only a first portion of the future time period.

14. The apparatus of claim 8, wherein the client device comprises a wireless mobile device.

15. A non-transitory computer readable medium embodying a computer program, the computer program comprising computer readable program code for:
determining a link quality or throughput in at least one of: a first link from a server to an intermediate node or a second link from the intermediate node to a client device;
based on the determined link quality or throughput, estimating a link quality in a future time period for at least one of: the first link or the second link;
determining a schedule for downloading video segments from the server to a cache associated with the intermediate node, the schedule determined based on the estimated link quality in the future time period; and
downloading video segments according to the schedule from the server to the cache during the future time period, in order to make the video segments available in the cache for transmission to the client device.

16. The non-transitory computer readable medium of claim 15, wherein the schedule comprises at least one transmission bitrate for downloading the video segments.

17. The non-transitory computer readable medium of claim 15, wherein the schedule is determined using an algorithm that optimizes a quality of experience (QoE) for the client device.

18. The non-transitory computer readable medium of claim 17, wherein the algorithm determines a plurality of potential schedules that are achievable in the future time period, and selects the schedule that optimizes the QoE for the client device.

19. The non-transitory computer readable medium of claim 18, wherein the QoE is defined as a set of quality metrics, including an average bitrate and a temporal variability.

20. The non-transitory computer readable medium of claim 1, wherein the video segments are downloaded according to the schedule from the server to the cache during only a first portion of the future time period.
